(19) United States
(12) Patent Application Publication
(10) Pub. No.: US 2017/0216792 A1
(43) Pub. Date: Aug. 3, 2017

(54) A FLOW DISPERSER

(71) Applicant: ICHEMAD -PROFARB SP. Z O.O., Gliwice (PL)

(72) Inventors: ADAMEK Marian, Gliwice (PL); Radoslaw ADAMEK, Gliwice (PL); Krzysztof DANEK, Gliwice (PL)

(21) Appl. No.: 15/500,533

(22) PCT Filed: Jul. 14, 2015
(86) PCT No.: PCT/IB2015/055310

§ 371 Date: Jan. 31, 2017

(30) Foreign Application Priority Data
Aug. 1, 2014 (PL) P.409058

(51) Int. Cl. B01F 7/06; B01F 3/12; B01F 7/00

(52) U.S. Cl. CPC B01F 7/063; B01F 7/0075; B01F 3/1221; B01F 2003/125; B01F 2215/005

(57) ABSTRACT

The subject of the invention is a flow disperser for mixing substances, in particular for breaking up, dissolving and emulsifying liquids and/or powders. A flow disperser comprising a casing equipped with a perforated inner stator and a rotating drive shaft with a fixed impeller according to the invention is characteristic in that the impeller (4) with the swirling baffle (5) divides the mixing area into two mixing chambers (6) and (7), wherein the inlet port of the mixture ingredients (8) for the mixing chamber (6) is located in the axis of the casing (1) with the fixed impeller (4) and the outlet (9) of the product is made in the side surface of the casing (1) in the mixing chamber (7).

The subject of the invention is a flow disperser for mixing substances, in particular for breaking up, dissolving and emulsifying liquids and/or powders.

Patent application P.296231 describes a disperser for dispersing broken-up solids in fluid mediums, in particular in high viscosity liquids, characteristic in that it comprises a screen basket filled with beads, fixed to the end of a hollow shaft. There is a disc with caps fixed to the end of the inner shaft. The hollow shaft and the inner shaft are arranged in a console mounted on an extension arm attached to the column of the disperser casing. The hollow shaft is connected to a drive via a transmission and the inner shaft is equipped with a brake.

Patent application PL.212189 describes a basket mill for mixing, dispersing and blending suspensions, pigments and fillers. The basket mill according to that invention comprises a basket, which is made as a cylindrical container featuring double walls and a screen bottom and with an inlet from the top, formed in the shape of a concave cone fixed to the cover of the vat and equipped with a water cooling system. On the shaft of the basket, outside the basket there is a mixer whereas inside the basket a working disc rotates which is mounted to the bottom part of the shaft above the mixer.

European patent description EP 1 282 465 discloses a device for mixing substances, in particular for dispersing, suspending and emulsifying gases and/or liquids and/or flowable solids, comprising a rotor with a separating screen or a group of separating screens, an inner wing and an outer wing as well as a pot-shaped stator, whose wall is perforated up to the edge of the metal bridge limiting the stator, the said wall being situated between the inner wings and the outer wings of the rotor, wherein the rotor and the stator are arranged in a mixing chamber, into which on one side of the separating screen there is an inlet port of the first product and on the other side of the respective separating screen there is an inlet port of the second product and the outlet port of the product belonging to the separating screen, according to the invention is characteristic in that the edge of the metal bridge is placed in the plane of the separating screen and this very screen or any of the separating screens divides the mixing chamber into separate mixing zones, which prevents the exchange of substances between the mixing zones within the mixing chamber. The water-air mixer comprises a mixing chamber connected with a ballast plate by means of a conic element and supports. On the ballast plate there is a spray head mounted by means of brackets. Over the mixing chamber there is a slidable conical disc secured with screws in a flange.

The aim of the invention is to construct a flow disperser operating in a continuous way, with a mixing chamber divided by an impeller.

A flow disperser comprising a casing equipped with a perforated inner stator and a rotating drive shaft with a fixed impeller according to the invention is characteristic in that the impeller with the swirling baffle divides the mixing area into two mixing chambers, wherein the inlet port of the mixture ingredients for the mixing chamber is located in the geometric axis of the casing with the fixed impeller and the outlet port of the product is made in the side surface of the casing in the mixing chamber.

Favourably, inside the casing, in the mixing chamber there is an additional inlet port for the mixture ingredients.

The main advantage of the invention is the continuous operation of the device which ensures repeatable quality of the homogenized material obtained by mixing and breaking up of both solid and fluid ingredients.

In dispenser tanks preparing large manufactured units in a single work cycle the problem is to obtain repeatable manufactured units, which is particularly significant while breaking up and mixing paints and varnishes. A flow disperser ensures low flow volume of a single manufactured unit, which results in shortening the blending time while simultaneously lowering the amount of energy used in the process.

The use of a flow disperser eliminates the costs connected with buying, using and maintenance of filtering devices and the difficult problem of utilizing the post-filtration waste. The power consumption is significantly reduced, which results in notable economic benefits.

Moreover, as a result of dispensing directly into the flowing liquid, dustiness is lowered while introducing dry materials, which improves working conditions at the work station.

The subject of the invention is shown in the drawing, where:

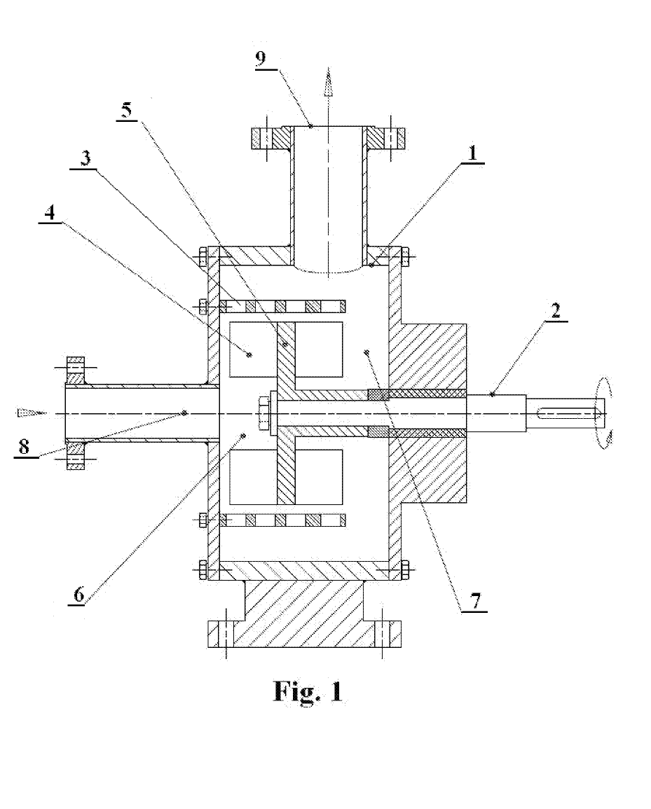

FIG. 1—presents the disperser in section;

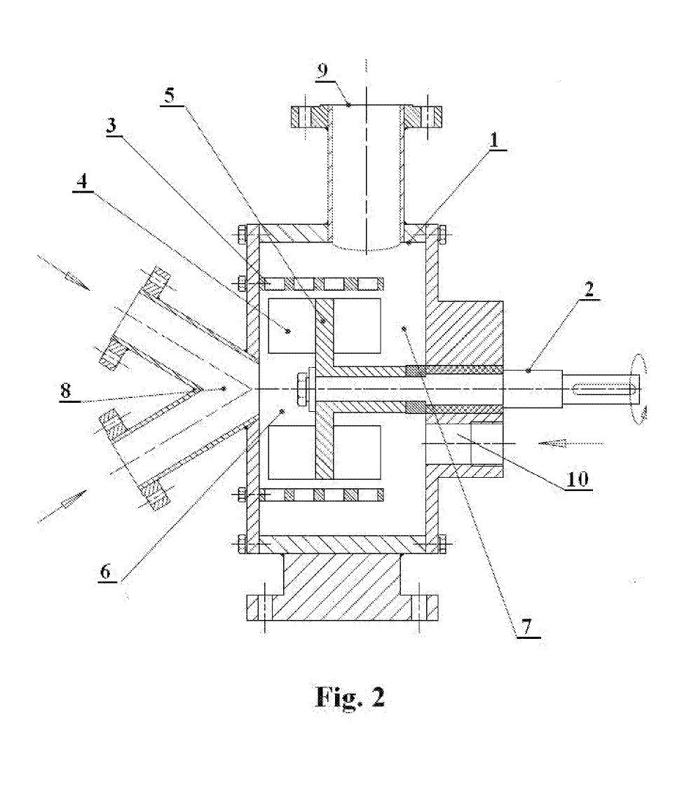

FIG. 2—presents an embodiment of the disperser in section;

### EMBODIMENT 1

A flow disperser comprising a cylindrical casing 1 equipped with a fixed perforated inner stator 3, a rotating drive shaft 2 with a fixed impeller 4. The impeller 4 with a swirling baffle 5 divides the mixing area into two mixing chambers 6 and 7. The inlet port of the mixture ingredients 8 to the mixing chamber 6 is located in the axis of the casing 1 with the fixed impeller 4. The inlet port of the mixture ingredients 8 may be an assemble of inlet ports. On the side surface of the casing 1 in the mixing chamber 7 there is an outlet opening 9.

### EMBODIMENT 2

In another embodiment of the invention the flow disperser comprises a cylindrical casing 1 equipped with a fixed perforated inner stator 3, a rotating drive shaft 2 with a fixed impeller 4. The impeller 4 with a swirling baffle 5 divides the mixing area into two mixing chambers 6 and 7. The inlet port of the mixture ingredients 8 to the mixing chamber 6 is located in the axis of the casing 1 with the fixed impeller 4. The inlet port of the mixture ingredients 8 is an assembly of inlet ports. On the side surface of the casing 1 in the mixing chamber 7 there is an outlet opening 9. Moreover, inside the casing 1 in the mixing chamber 7 there is an additional inlet 10 which enables introducing additional ingredients.

1. A flow disperser comprising a casing equipped with a perforated inner stator and a rotating drive shaft with a fixed impeller, characteristic in that the impeller (4) with the swirling baffle (5) divides the mixing area into two mixing chambers (6) and (7), wherein the inlet port of the mixture ingredients (8) for the mixing chamber (6) is located in the axis of the casing (1) with the fixed impeller (4) and the outlet (9) of the product is made in the side surface of the casing (1) in the mixing chamber (7).

2. A flow disperser according to claim 1, characteristic in that inside the casing (1) in the mixing chamber (7) there is an additional inlet port (10).
